(19) United States
(12) Patent Application Publication
(10) Pub. No.: US 2024/0144640 A1
(43) Pub. Date: May 2, 2024

(54) METHOD AND APPARATUS FOR PROCESSING IMAGE BASED ON NEURAL NETWORK

(71) Applicants: SAMSUNG ELECTRONICS CO., LTD., Suwon-si (KR); KOREA UNIVERSITY RESEARCH AND BUSINESS FOUNDATION, Seoul (KR)

(72) Inventors: Jong Ok KIM, Seoul (KR); Jeong Won HA, Seoul (KR); Dong Keun HAN, Seoul (KR)

(21) Appl. No.: 18/193,780

(22) Filed: Mar. 31, 2023

(30) Foreign Application Priority Data
Oct. 27, 2022 (KR) 10-2022-0140546

(51) Int. Cl. G06V 10/60; G06V 10/77; G06V 10/82

(52) U.S. Cl. CPC G06V 10/60; G06V 10/7715; G06V 10/82

(57) ABSTRACT

Provided is a method and an apparatus for processing an image based on a neural network. The method includes forming an input image set by combining a visible light image and an infrared image, estimating an illuminant map representing an illuminant configuration of the input image set and a confidence score map representing a correlation between the visible light image and the infrared image, using a neural network model, and determining illuminant information of the visible light image based on the illuminant map and the confidence score map.

### CROSS-REFERENCE TO RELATED APPLICATIONS

This application claims priority under 35 USC § 119(a) to Korean Patent Application No. 10-2022-0140546, filed on Oct. 27, 2022, in the Korean Intellectual Property Office, the disclosure of which is incorporated by reference herein in its entirety.

### BACKGROUND

The present disclosure relates to a method and an apparatus for image processing, and more specifically, for image processing using neural networks.

Digital image processing generally refers to the process of making changes to a digital image using a computer or other electronic device. For example, a computer may use an algorithm or a processing network to make changes to a digital image. In some examples, a neural network may be used for image processing. The neural network may be trained based on deep learning, and during inference, the neural network may map input data to output data. The input data and the output data may have a nonlinear relationship. The neural network may learn the mapping between the input data and the output data during training. In some examples, the neural network may be trained for a special purpose, such as image restoration. However, the neural network may also be capable of generalization (e.g., identifying general features of input data) such that the neural network generates a relatively accurate output based on new, unseen input data.

### SUMMARY

This Summary introduces a selection of concepts and does not limit the scope of the claimed subject matter.

In one general aspect, a method includes forming an input image set by combining a visible light image and an infrared image, estimating an illuminant map representing an illuminant configuration of the input image set and a confidence score map representing a correlation between the visible light image and the infrared image, using a neural network model, and determining illuminant information of the visible light image based on the illuminant map and the confidence score map.

In another general aspect, an apparatus includes a processor and a memory configured to store instructions executable by the processor, wherein in response to the instructions being executed by the processor, the processor is configured to form an input image set by combining a visible light image and an infrared image, estimate an illuminant map representing an illuminant configuration of the input image set and a confidence score map representing a correlation between the visible light image and the infrared image, using a neural network model, and determine illuminant information of the visible light image based on the illuminant map and the confidence score map.

In another general aspect, an electronic device includes a visible light camera configured to generate a visible light image, an infrared camera configured to generate an infrared image, and a processor configured to form an input image set by combining the visible light image and the infrared image, estimate an illuminant map representing an illuminant configuration of the input image set and a confidence score map representing a correlation between the visible light image and the infrared image, using a neural network model, and determine illuminant information based on the illuminant map and the confidence score map.

In another general aspect, a method includes obtaining a first image and a second image, wherein the second image records light from a different spectral range from the first image, generating, using a neural network model, illuminant information based on the first image and the second image, and generating a modified image based on the first image and the illuminant information.

Other features and aspects will be apparent from the following detailed description, the drawings, and the claims.

### BRIEF DESCRIPTION OF THE DRAWINGS

FIG. 1 illustrates an example of an image processing process using a neural network model.

FIG. 2 illustrates an example of a structure of a neural network model.

FIG. 3 illustrates an example of a structure of a first sub-model.

FIG. 4 illustrates an example of a structure of a second sub-model.

FIG. 5 illustrates an example of a structure of a cross-attention block.

FIG. 6 illustrates an example of a white balance operation using an illuminant vector.

FIG. 7 illustrates an example of structures of a confidence score map and an illuminant map.

FIGS. 8, 9, and 10 illustrate examples of other structures of a neural network model.

FIG. 11 illustrates an example of an image processing method.

FIG. 12 illustrates an example of a configuration of an image processing apparatus.

FIG. 13 illustrates an example of a configuration of an electronic device.

FIG. 14 illustrates an image processing system.

FIG. 15 illustrates a method for image processing.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The present disclosure relates to a method and device for image processing, and more specifically, for determining the illumination or lighting of an image using a neural network such that colors in the image may be corrected.

When an object is illuminated by light from a light source, the colors of an image of the object may be affected by the light. For example, the light may change the way colors are perceived by a camera or by a human eye. Light sources may emit different amounts of light at different wavelengths of the color spectrum due to different spectral power distributions. When the same object is illuminated by different light sources, it may appear to have different colors. This can result in an inaccurate or undesirable representation of the color of the object in a captured image. Color constancy technology or color correction technology (e.g., white balancing technology) may be used to correct color representation in images. For example, color constancy technology may estimate the lighting conditions present when an image was captured and adjust the image to compensate for the effects of the light source, resulting in a more accurate representation of the true colors in the image.

Embodiments of the present disclosure support accurate estimation of the lighting or illumination affecting an image to enable accurate image color correction. An image processing apparatus may generate an illumination map that indicates the effects of illumination on an image, and the image processing apparatus may generate a confidence score map that indicates the likelihood that an estimation of an effect of illumination on an image is accurate. The image processing apparatus may then determine illumination information (e.g., a vector) indicating the effects of illumination on an image based on the illumination map and the confidence score map. Because the image processing apparatus may consider the likelihood that an estimation of illumination affecting an image is accurate based on the confidence score map, illumination information generated based on the confidence score map may be more accurate. Thus, color correction performed based on the illumination information may be more accurate.

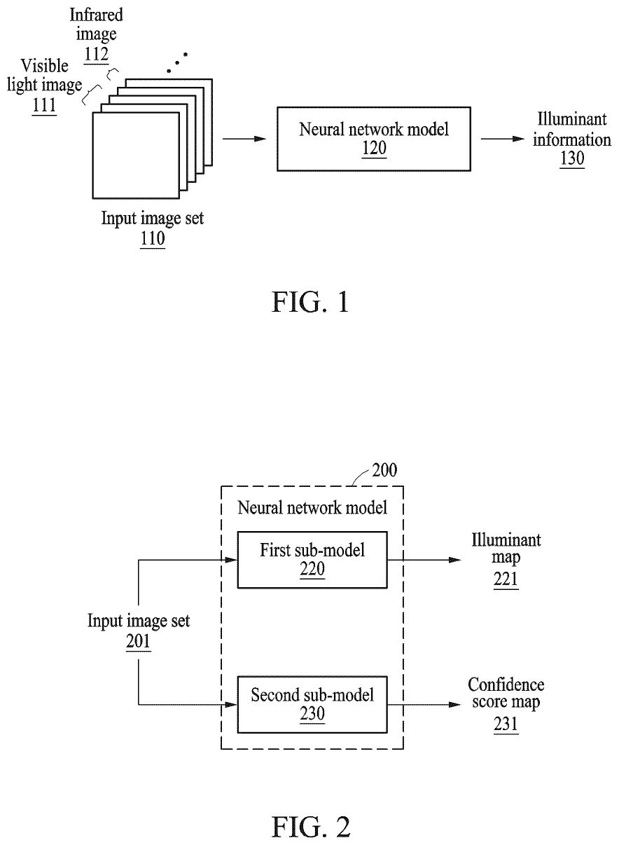

FIG. 1 illustrates an example of an image processing process using a neural network model. An image processing apparatus may generate illuminant information 130 from an input image set 110 using a neural network model 120. The neural network model 120 may include a deep neural network (DNN) including a plurality of layers. The plurality of layers may include an input layer, at least one hidden layer, and an output layer.

A DNN may include at least one of a fully connected network (FCN), a convolutional neural network (CNN), or a recurrent neural network (RNN). For example, a portion of the layers included in the neural network may correspond to a CNN, and another portion of the layers may correspond to an FCN. The CNN may be referred to as a convolutional layer and the FCN may be referred to as a fully connected layer.

An FCN is a class of neural network in which each node in one layer is connected to each node in a subsequent layer. The basic structure of an FCN consists of an input layer that receives input data, one or more hidden layers that perform computation and non-linear transformations on the input data, and an output layer that produces final predictions. The hidden layers can contain many nodes, and each node in a layer may receive input from all nodes in the previous layer and may produce output to all nodes in a next layer. FCNs are widely used for a variety of tasks, including image classification, natural language processing, and speech recognition. In these tasks, the input data is usually transformed into a feature representation that summarizes the important information. The hidden layers then process these features to make predictions or decisions.

A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a pass of the CNN, filters at each layer may be convolved across the input volume, computing the dot product between the filter and the input. During the training process, the filters may be modified so that they activate when they detect a particular feature within the input.

In a CNN, data input to each layer may be referred to as an input feature map and data output from each layer may be referred to as an output feature map. The input feature map and the output feature map may also be referred to as activation data. When the convolutional layer corresponds to the input layer, the input feature map of the input layer may be an image.

An RNN is a class of neural network in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

After being trained based on deep learning, a neural network may perform inference based on the training by mapping input data to output data. The input data and the output data may have a nonlinear relationship. A neural network trained using deep learning may be used for image or voice recognition (e.g., in a big data set). In some examples, deep learning may be described as a process of solving an optimization problem to find a point at which energy is minimized when training a neural network based on prepared training data. Deep learning may include supervised learning and unsupervised learning.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

Unsupervised learning draws inferences from datasets consisting of input data without labeled responses. Unsupervised learning may be used to find hidden patterns or grouping in data. For example, cluster analysis is a form of unsupervised learning. Clusters may be identified using measures of similarity such as Euclidean or probabilistic distance.

Through supervised or unsupervised deep learning, one or more weights in a neural network corresponding to a structure or model of the neural network may be obtained. The neural network may then map input data to output data based on the one or more weights in the neural network. When a width and a depth of the neural network are sufficiently large, the neural network may have a capacity large enough to implement an arbitrary function. When the neural network is trained on a sufficiently large quantity of training data through an appropriate training process, optimal performance may be achieved.

In some examples, a neural network may be trained in advance of inference time. For instance, being trained “in advance of inference time” may refer to training “before” the neural network is started. A “started” neural network may refer to a neural network that is ready for inference. For example, “starting” the neural network may include loading the neural network into memory, or “starting” the neural network may include accepting input data for inference after the neural network is loaded into memory.

The input image set 110 may include a visible light image 111 and an infrared image 112. The visible light image 111 may include a sub-image of a red (R) channel, a sub-image of a green (G) channel, and a sub-image of a blue (B) channel. The infrared image 112 may include sub-images of a multi-band. The multi-band may include N infrared bands (e.g., 3, 5, or 8 infrared bands). The infrared image 112 may include N sub-images according to the N infrared bands. According to an example, the N infrared bands may have the same bandwidth. The visible light image 111 may use a band of 400 nm to 700 nm and the infrared image 112 may use a near infrared (NIR) band of 700 nm to 1000 nm. For example, the NIR band may be divided into N parts to form N multi-band sub-images of the infrared image 112.

The image processing apparatus may use the visible light image 111 and the infrared image 112 for estimating the illuminant information 130. Because the NIR band is out of the visible light band, it may not be observed by human eyes. However, because the NIR band is adjacent to the visible light band, it may share some reflection characteristics with the visible light band. In addition, the infrared image 112 may have characteristics that are more robust to a capture environment than the visible light image 111. In some examples, the reflection characteristics of the NIR band may vary based on a surface material of an object.

The image processing apparatus may estimate the illuminant information 130 using a correlation between the visible light image 111 and the infrared image 112. The illuminant information 130 may represent an effect of illumination on an input image (e.g., the visible light image 111). For example, the illuminant information 130 may include an illuminant vector. The illuminant vector may include an R-channel illuminant value, a G-channel illuminant value, and a B-channel illuminant value. The image processing apparatus may use the correlation between the visible light image 111 and the infrared image 112 more effectively by using the NIR band of the multi-band.

The illuminant information 130 may be used in a color constancy technique to estimate a color of an object in an image based on illumination. For example, white balancing for an input image (e.g., the visible light image 111) may be performed using the illuminant information 130. Due to illumination, the color of an object in an image generated by a camera and the actual color of an object may differ. The color constancy technique may eliminate or mitigate the effects of illumination on colors in an image. The color constancy technique may be an example of an image preprocessing technique or process.

According to an example, the image processing apparatus may form the input image set 110 by combining the visible light image 111 and the infrared image 112. The image processing apparatus may use the neural network model 120 to estimate an illuminant map representing an illuminant configuration of the input image set 110 and a confidence score map representing a correlation between the visible light image 111 and the infrared image 112. The image processing apparatus may then determine the illuminant information 130 based on (e.g., by fusing) the illuminant map and the confidence score map. In a process of deriving the illuminant information 130, the correlation between the visible light image 111 and the infrared image 112 may be used.

According to an example, each of the visible light image 111 and the infrared image 112 may include local areas. The illuminant map may represent an illuminant configuration for each local area. The illuminant map may correspond to the illuminant information 130 for each local area. The local areas of the visible light image 111 and the local areas of the infrared image 112 may form corresponding pairs. The confidence score map may represent the correlation between the visible light image 111 and the infrared image 112 for each local area. The confidence score map may include weights for each of the corresponding pairs. If a correlation between visible light data and infrared data of a corresponding pair among the corresponding pairs is high, a weight of the corresponding pair may have a high value. The illuminant map and the confidence score map may be fused through a weighted sum. In this process, a local area with a high weight may have a greater influence on the illuminant information 130 than a local area with a low weight.

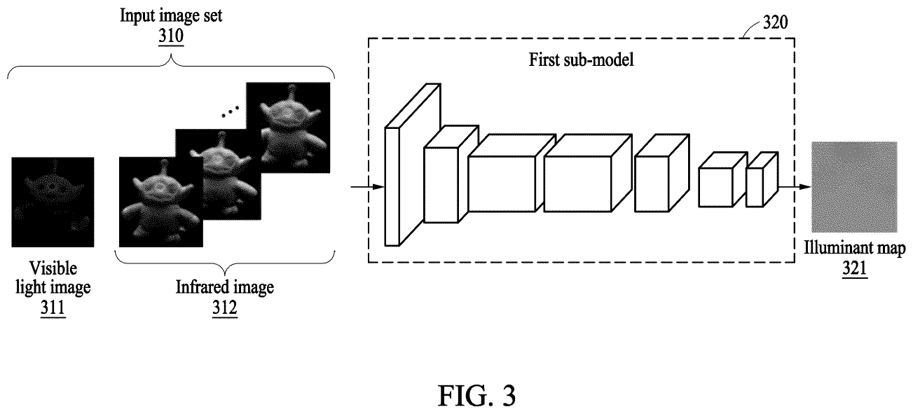

FIG. 2 illustrates an example of a structure of a neural network model. Referring to FIG. 2, a neural network model 200 may include a first sub-model 220 that estimates an illuminant map 221 from an input image set 201 and a second sub-model 230 that estimates a confidence score map 231 from the input image set 201.

The illuminant map 221 may represent an illuminant configuration for each local area. The illuminant configuration may correspond to a set of parameters, values, or data representing the illumination of a visible light image or the illumination of a local area of a visible light image. According to an example, the input image set 201 may include local areas. For example, the input image set 201 may have a dimension of H×W×C. H may represent a dimension in a height direction, W may represent a dimension in a width direction, and C may represent a dimension in a channel direction. The input image set 201 may include a visible light image of dimension H×W×c1 and an infrared image of dimension H×W×c2. C may be c1+c2 (i.e., C=c1+c2). For example, c1 may be 3 (i.e., c1=3) according to the R-channel, the G-channel, and the B-channel. c2 may be N (i.e., c2=N). N may be the number of multi-bands of the infrared image. For example, the illuminant map 221 may have a dimension of H/k×W/k×c1.k may represent a ratio between a two-dimensional (2D) dimension of the input image set 201 and a 2D dimension of the illuminant map 221. k may correspond to a downscale ratio of the visible light image according to the first sub-model 220. When the input image set 201 is projected in the channel direction, a 2D image may have a dimension of H×W and include local areas of dimension H/k×W/k. Each channel vector in the channel direction of the illuminant map 221 may represent an illuminant configuration of a corresponding local area of the 2D image. For example, the illuminant configuration may include an illuminant vector. The illuminant vector may include an R-channel illuminant value, a G-channel illuminant value, and a B-channel illuminant value.

The confidence score map 231 may represent a correlation between the visible light image and the infrared image for each local area. Each of the visible light image and the infrared image may be expressed as a 2D image and may include local areas of dimension H/k×W/k. The visible light image and the infrared image may include corresponding local areas. The corresponding local areas may be referred to as corresponding pairs. The visible light image and the infrared image may include corresponding pairs of dimension H/k×W/k. The confidence score map 231 may have a dimension of H/k×W/k. Each confidence score of the confidence score map 231 may represent a correlation of each corresponding pair. The higher the correlation between the corresponding pair, the higher the confidence score of the corresponding pair. That is, the second sub-model may determine a higher confidence score for corresponding pairs with higher correlation.

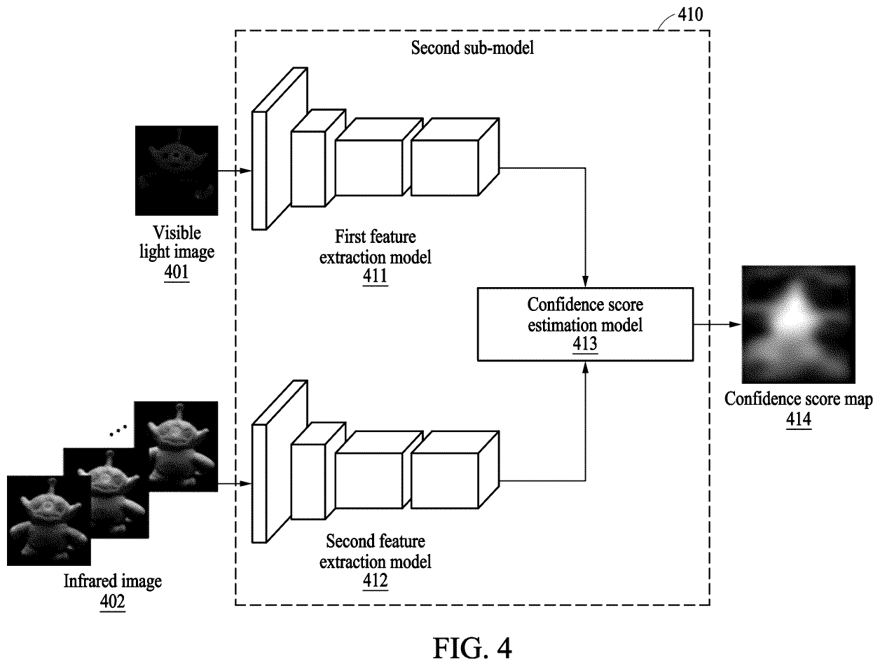

FIG. 3 illustrates an example of a structure of a first sub-model. Referring to FIG. 3, a first sub-model 320 may estimate an illuminant map 321 from an input image set 310. The input image set 310 may include a visible light image 311 and an infrared image 312. The visible light image 311 and the infrared image 312 may be concatenated and may form the input image set 310. For example, the input image set 310, the visible light image 311, and the infrared image 312 may have dimensions of H×W×C, H×W×c1, and H×W×c2, respectively, and C may be c1+c2 (i.e., C=c1+c2). The first sub-model 320 may include a convolutional layer and a pooling layer. The first sub-model 320 may estimate the illuminant map 321 by extracting a feature from the input image set 310. Since both visible light information and infrared information are used together, the greater the contribution of the infrared information, the higher the accuracy of illuminant estimation.

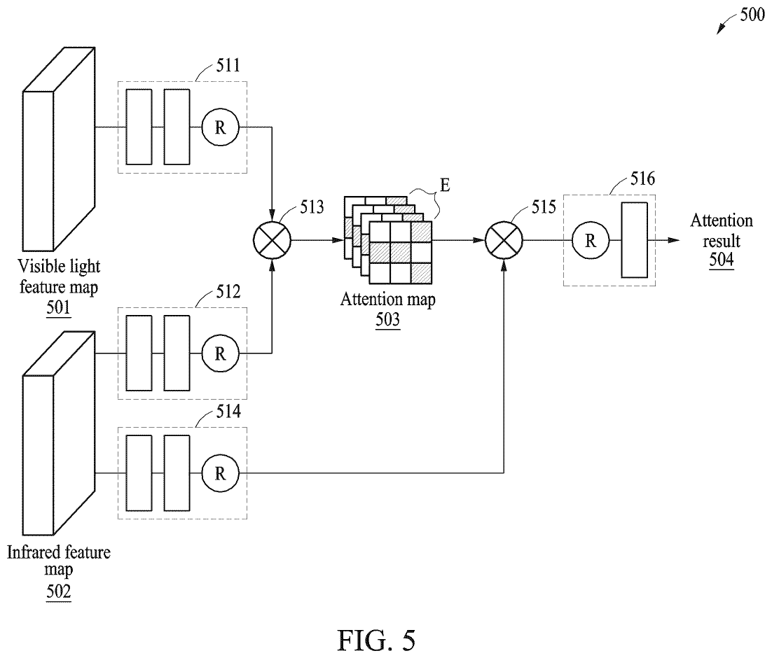

FIG. 4 illustrates an example of a structure of a second sub-model. Referring to FIG. 4, a second sub-model 410 may estimate a confidence score map 414 from a visible light image 401 and an infrared image 402 of an input image set. The second sub-model 410 may include a first feature extraction model 411 that extracts a visible light feature map from the visible light image 401, a second feature extraction model 412 that extracts an infrared feature map from the infrared image 402, and a confidence score estimation model 413 that estimates the confidence score map 414 based on a correlation between the visible light feature map and the infrared feature map. The first feature extraction model 411 and the second feature extraction model 412 may include a convolutional layer and a pooling layer, respectively, and may perform a feature extraction operation. The confidence score estimation model 413 may include a cross-attention block and a convolutional layer.

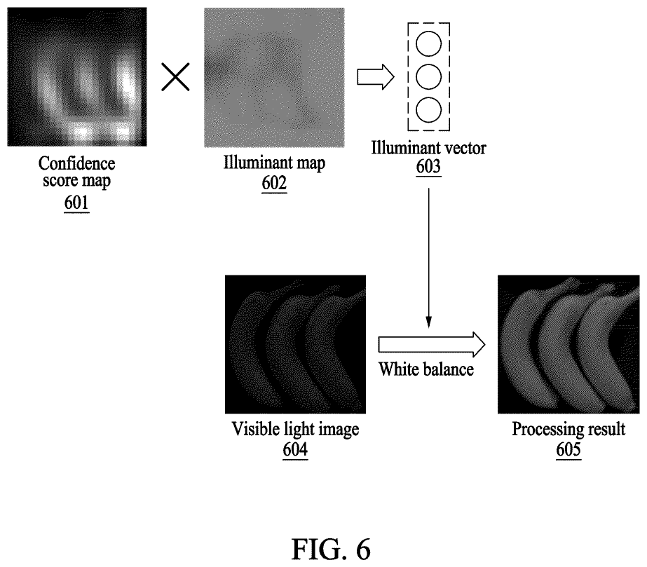

FIG. 5 illustrates an example of a structure of a cross-attention block. Referring to FIG. 5, a cross-attention block 500 may fuse a visible light feature map 501 and an infrared feature map 502. The visible light feature map 501 and the infrared feature map 502 may each have a dimension of h×w×c. The higher a correlation between visible light information and infrared information in an area, the higher the accuracy of an illuminant estimation in the area, and the higher a score that may be assigned to the area.

Query data according to the visible light feature map 501 may be determined through an operation layer group 511, and key data according to the infrared feature map 502 may be determined through an operation layer group 512. Each of the operation layer group 511 and the operation layer group 512 may include convolutional layers (e.g., a 1×1 convolutional layer and a 3×3 convolutional layer) and a reshape operation. The query data may have a dimension of c×hw and the key data may have a dimension of hw×c. An operation result may be determined through a dot product operation 513 between the query data and the key data and an attention map 503 may be obtained by inputting a multiplication result to a softmax function. The attention map 503 may have a dimension of c×c and a head number of E.

Value data according to the infrared feature map 502 may be determined through an operation layer group 514. The operation layer group 514 may include convolutional layers (e.g., a 1×1 convolutional layer and a 3×3 convolutional layer) and a reshape operation. An operation result may be determined through a dot product operation 515 between the attention map 503 and the value data, and an attention result 504 may be determined through the operation layer group 516 for the operation result. The operation layer group 516 may include a reshape operation and a convolutional layer (e.g., a 1×1 convolutional layer). The attention result 504 may have a dimension of h×w×c. A confidence score map may be determined as the attention result 504 passes through the convolutional layer.

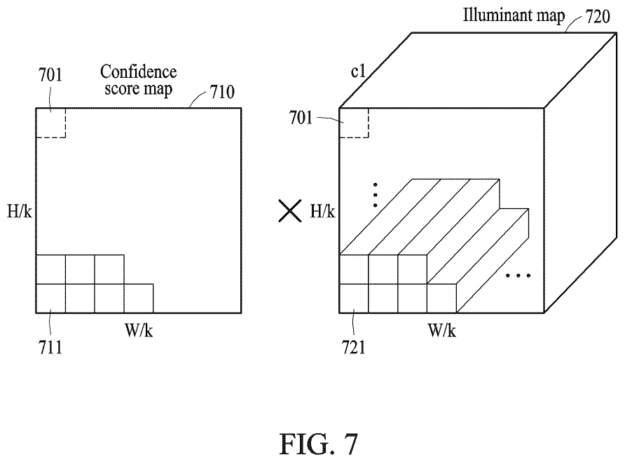

FIG. 6 illustrates an example of a white balance operation using an illuminant vector. White balance technology includes a statistics-based technique and a machine learning based technique. The statistics-based white balance technique uses statistical features of an image to estimate lighting, such as the average red, green, and blue (RGB) ratios. For example, statistics-based lighting estimation technology may assume that the average RGB ratio of the image should be an achromatic color, which has a RGB ratio of 1:1:1, and may correct the average RGB ratio of the image to 1:1:1. A machine learning based white balance technique uses a neural network trained with images and corresponding lighting information to estimate lighting.

Referring to FIG. 6, the image processing apparatus may obtain a weighted sum between a confidence score map 601 and an illuminant map 602 and determine illuminant information according to the weighted sum. For example, the illuminant information may include an illuminant vector 603. The illuminant vector 603 may include an R-channel illuminant value, a G-channel illuminant value, and a B-channel illuminant value. Equation 1 may be used as a loss function.

$$L = {cos}^{- 1} ( \frac{{Γ}_{gt} \cdot {Γ}_{est}}{‖ {Γ}_{gt} ‖ ‖ {Γ}_{est} ‖} ) \qquad [ Equation 1 ]$$

The term “loss function” refers to a function that impacts how a machine learning model is trained. For example, during each training iteration, the output of the model can be compared to known annotation information in the training data. The loss function provides a value (i.e., a “loss”) based on how close the predicted data is to the actual annotation data. After computing the loss, parameters of the model are updated accordingly, and a new set of predictions are made during the next iteration.

In Equation 1, L may represent a loss, Γₑₛₜ may represent an illuminant vector, and Γ_{gt} may represent a ground truth (GT). The loss L may represent an angular error between the illuminant vector Γₑₛₜ and GT Γ_{gt}. The illuminant vector 603 may be used to process white balance for a visible light image 604. An output image may be determined based on a processing result 605.

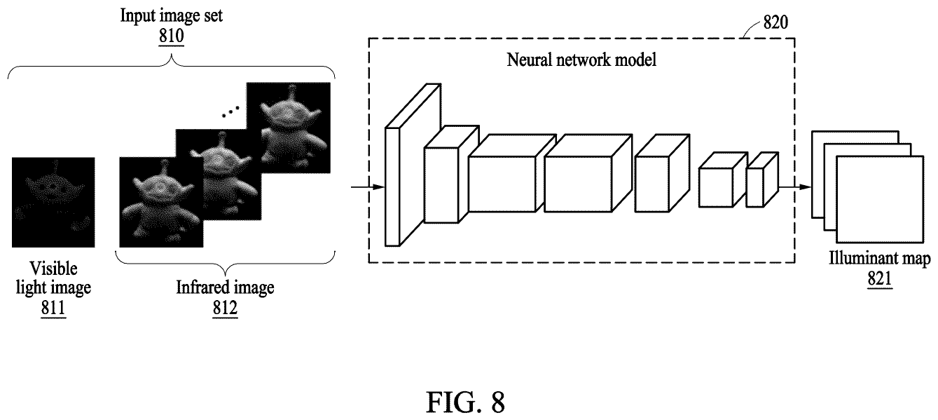

FIG. 7 illustrates an example of structures of a confidence score map and an illuminant map. Referring to FIG. 7, a dimension of a confidence score map 710 may be H/k×W/k. The confidence score map 710 may include local areas, such as a local area 701. The number of local areas may be H/k×W/k. The confidence score map 710 may include confidence score values such as a confidence score value 711. The number of confidence score values may be H/k×W/k. A dimension of an illuminant map 720 may be H/k×W/k×c1. For example, c1 may be 3 (i.e., c1=3) according to an R-channel, a G-channel, and a B-channel. The illuminant map 720 may include local areas, such as a local area 702. The number of local areas may be H/k×W/k. The local areas 701 and 702 of corresponding positions may form operation pairs. The illuminant map 720 may include illuminant vectors, such as an illuminant vector 721. The illuminant vector 721 may include an R-channel illuminant value, a G-channel illuminant value, and a B-channel illuminant value. The number of illuminant vectors may be H/k×W/k.

The image processing apparatus may obtain a weighted sum by summing illuminant vectors for each local area according to the illuminant map 720 using a weight according to the confidence score map 710. The local areas of the visible light image and the local areas of the infrared image may form corresponding pairs. Confidence score values of the confidence score map 710 may determine weights for the corresponding pairs. The higher a correlation between visible light data and infrared data of a corresponding pair among the corresponding pairs, the higher the confidence score and the weight of the corresponding pair may be. An illuminant vector of 1×1×c1 may be determined through a weighted sum between the illuminant map 720 and the confidence score map 710. Since the accuracy of an illuminant estimation differs according to the local area of an image, the neural network model may train the reliability of illumination for each area together. One illuminant vector may be determined through a weighted sum according to the reliability of the illumination for each area. The illuminant vector may be used for white balancing of an input image (e.g., a visible light image).

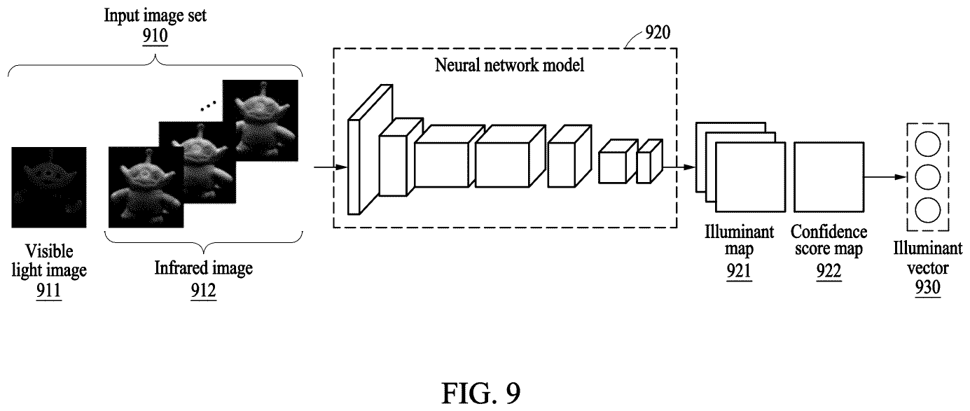

FIGS. 8, 9, and 10 illustrate examples of other structures of a neural network model. Referring to FIG. 8, an input image set 810 may include a visible light image 811 and an infrared image 812. An illuminant map 821 corresponding to the input image set 810 may be estimated through a single model of a neural network model 820. The illuminant map 821 may include local areas corresponding to different illuminant vectors. When white balance processing is performed for an input image (e.g., the visible light image 811), different illuminant vectors of the illuminant map 821 may be applied to local areas of the input image. Complex illumination may be estimated through the illuminant vectors of the illuminant map 821.

Referring to FIG. 9, an input image set 910 may include a visible light image 911 and an infrared image 912. An illuminant map 921 and a confidence score map 922 corresponding to the input image set 910 may be estimated through a single model of a neural network model 920. The neural network model 920 may be trained to output the illuminant map 921 and the confidence score map 922 as a single model. One illuminant vector 930 may be determined through a weighted sum between the illuminant map 921 and the confidence score map 922.

Referring to FIG. 10, a neural network model 1010 may include a first feature extraction model 1011 and a second feature extraction model 1012. The first feature extraction model 1011 may estimate an illuminant map 1013 from a visible light image 1001 of an input image set. The second feature extraction model 1012 may estimate a confidence score map 1014 from an infrared image 1002 of the input image set. The first feature extraction model 1011 and the second feature extraction model 1012 may include a convolutional layer and a pooling layer, respectively. The second feature extraction model 1012 may estimate the confidence score map 1014 through a feature extraction operation without a separate attention block. One illuminant vector 1020 may be determined through a weighted sum between the illuminant map 1013 and the confidence score map 1014.

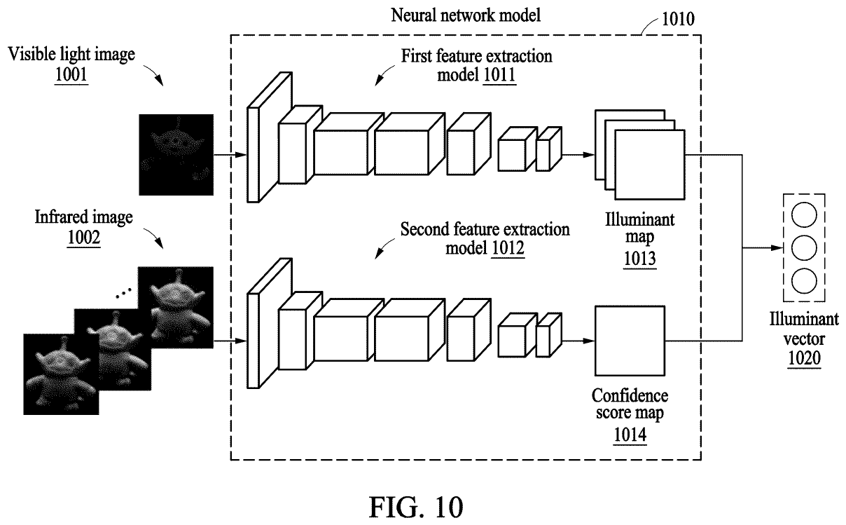

FIG. 11 illustrates an example of an image processing method. Referring to FIG. 11, the image processing apparatus may form an input image set by combining a visible light image and an infrared image in operation 1110, estimate an illuminant map representing an illuminant configuration of the input image set and a confidence score map representing a correlation between the visible light image and the infrared image, using a neural network model in operation 1120, and determine illuminant information of the visible light image based on the illuminant map and the confidence score map in operation 1130. For example, the illuminant map may be concatenated or fused with the confidence score map.

The illuminant map may represent the illuminant configuration for each local area, and the confidence score map may represent the correlation between the visible light image and the infrared image for each local area.

The neural network model may include a first sub-model that estimates the illuminant map from the input image set and a second sub-model that estimates a confidence score map from the input image set.

The second sub-model may include a first feature extraction model that extracts a visible light feature map from the visible light image of the input image set, a second feature extraction model that extracts an infrared feature map from the infrared image of the input image set, and a confidence score estimation model that estimates the confidence score map based on a correlation between the visible light feature map and the infrared feature map.

The confidence score estimation model may estimate the confidence score map by determining first data corresponding to one of the visible light feature map and the infrared feature map and second data corresponding to another one, by generating an attention map based on (e.g., by fusing) query data according to the first data and key data according to the second data, and by using (e.g., by fusing) value data according to one of the first data and the second data and the attention map.

The infrared image may include a multi-band.

In operation 1130, obtaining a weighted sum between the illuminant map and the confidence score map and determining illuminant information according to the weighted sum may be included.

The obtaining of the weighted sum may include obtaining the weighted sum by summing vectors for each local area according to the illuminant map using a weight according to the confidence score map.

The local areas of the visible light image and the local areas of the infrared image may form corresponding pairs, and the confidence score map may determine or include weights for each of the correspondence pairs. As a correlation between visible light data and infrared data of a corresponding pair among the corresponding pairs is high, a weight of the corresponding pair may have a high value.

In addition, the description provided with reference to FIGS. 1 to 10, 12, and 13 may apply to the image processing method of FIG. 11.

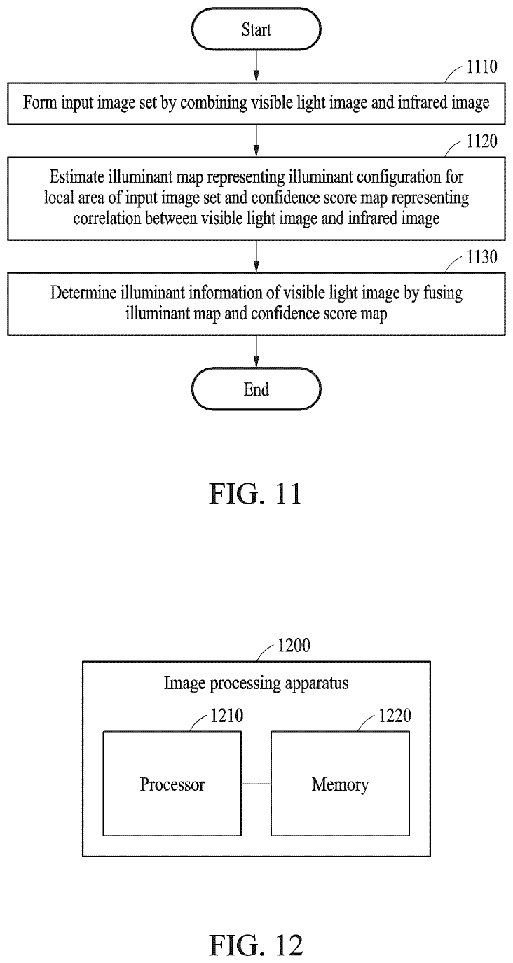

FIG. 12 illustrates an example of a configuration of an image processing apparatus. Referring to FIG. 12, an image processing apparatus 1200 may include a processor 1210 and a memory 1220. The memory 1220 is connected to the processor 1210 and may store instructions executable by the processor 1210, data to be used by the processor 1210, or data processed by the processor 1210. The memory 1220 may include non-transitory computer-readable media, for example, high-speed random access memory and/or non-volatile computer-readable storage media, such as, for example, at least one disk storage device, flash memory device, or other non-volatile solid state memory device.

The processor 1210 may execute the instructions to perform the operations of FIGS. 1 to 11 and 13. For example, the processor 1210 may form an input image set by combining a visible light image and an infrared image, estimate an illuminant map representing an illuminant configuration of the input image set and a confidence score map representing a correlation between the visible light image and the infrared image, and determine illuminant information of the visible light image based on the illuminant map and the confidence score map. In addition, the description provided with reference to FIGS. 1 to 11, and 13 may apply to the image processing apparatus 1200.

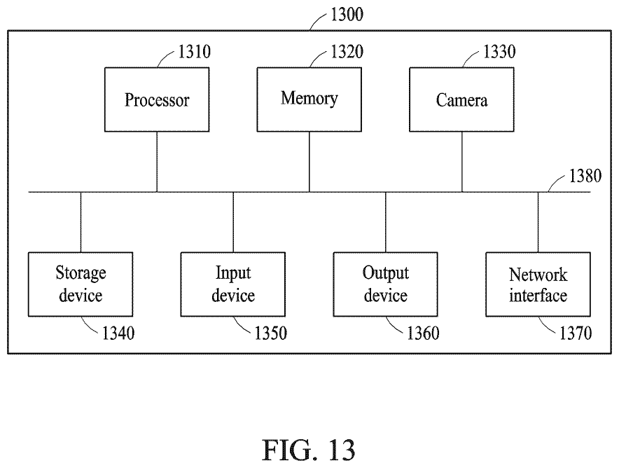

FIG. 13 illustrates an example of a configuration of an electronic device. Referring to FIG. 13, an electronic device 1300 may include a processor 1310, a memory 1320, a camera 1330, a storage device 1340, an input device 1350, an output device 1360, and a network interface 1370 that may communicate with each other through a communication bus 1380. The electronic device 1300 may be implemented as at least a portion of, for example, a mobile device such as a mobile phone, a smartphone, a personal digital assistant (PDA), a netbook, a tablet computer, a laptop computer, and the like, a wearable device such as a smart watch, a smart band, smart glasses, and the like, a home appliance such as a television (TV), a smart TV, a refrigerator, and the like, a security device such as a door lock and the like, and a vehicle such as an autonomous vehicle, a smart vehicle, and the like. The electronic device 1300 may structurally and/or functionally include the image processing apparatus 1200 of FIG. 12.

The processor 1310 executes functions and instructions for execution in the electronic device 1300. For example, the processor 1310 may process instructions stored in the memory 1320 or the storage device 1340. The processor 1310 may perform one or more operations described through FIGS. 1 to 12. The memory 1320 may include a computer-readable storage medium or a computer-readable storage device. The memory 1320 may store instructions to be executed by the processor 1310 and may store related information during execution of software and/or an application by the electronic device 1300.

The camera 1330 may generate an input image and/or an input image set. The input image may include a photo and/or video. The camera 1330 may include a visible light camera that generates a visible light image and an infrared camera that generates an infrared image. The visible light image and the infrared image may form an input image set. The storage device 1340 includes a computer-readable storage medium or computer-readable storage device. The storage device 1340 may store a larger amount of information than the memory 1320 and may store the information for a long period of time. For example, the storage device 1340 may include a magnetic hard disk, an optical disc, a flash memory, a floppy disk, or other types of non-volatile memory known in the art.

The input device 1350 may receive an input from users through a typical input method using a keyboard and a mouse and through a new input method, such as, for example, a touch input, a voice input, and an image input. For example, the input device 1350 may include a keyboard, a mouse, a touch screen, a microphone, or any other device that detects the input from users and transmits the detected input to the electronic device 1300. The output device 1360 may provide an output of the electronic device 1300 to users through a visual, auditory, or haptic channel. The output device 1360 may include, for example, a display, a touch screen, a speaker, a vibration generator, or any other device that provides the output to users. The network interface 1370 may communicate with an external device through a wired or wireless network.

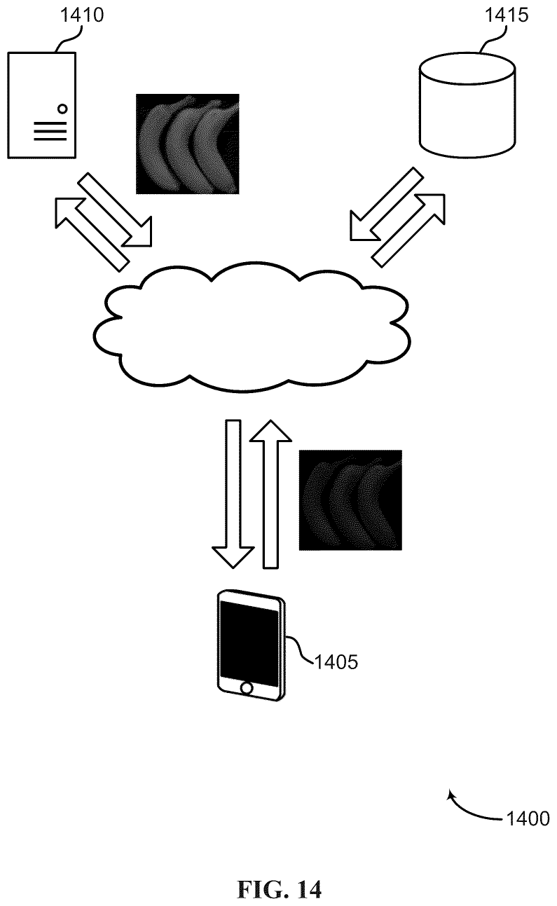

FIG. 14 illustrates an image processing system 1400. The image processing system 1400 includes a capturing device 1405, an image processing apparatus 1410, and a database 1415. The image processing system 1400 may be capable of generating and applying one or more neural networks capable of performing multiple image processing tasks on an image processing apparatus 1410 with limited hardware resources (e.g., limited processor or memory resources). The image processing apparatus 1410 may be an example of the image processing apparatus described with reference to FIGS. 1-13, and may perform the methods described herein.

In some examples, the capturing device 1405 may be a digital camera, surveillance camera, webcam, etc. The capture device may be used to capture a visible light image and send that captured, visible light image to the image processing apparatus 1410. The capture device may also be used to capture one or more infrared images and send the captured, infrared images to the image processing apparatus 1410. The visible light image and the one or more infrared images may make up an input image set.

In some examples, the image processing apparatus 1410 may be a computer or a smartphone. The image processing apparatus 1410 may also be a digital camera, surveillance camera, webcam, or any other suitable apparatus that has a processor for performing image processing.

A processor may be an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

The processor may execute software. Software may include code to implement aspects of the present disclosure. Software may be stored in a non-transitory computer-readable medium such as memory or other system memory. In some cases, the software may not be directly executable by the processor but may cause a computer (e.g., when compiled and executed) to perform functions described herein.

The memory may be a volatile memory or a non-volatile memory and may store data related to image processing methods described above with reference to FIGS. 1-13. Examples of a memory device include flash memory, random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

The image processing apparatus 1410 may include or be connected to one or more sensors. For example, the image processing apparatus 1410 may include or be connected to the capturing device 1405 for capturing an input image. The image processing apparatus 1410 may include or be connected to auxiliary sensors including a photoresistor sensor or an ambient light sensor for sensing ambient light.

In one example, image processing apparatus 1410 may generate an illumination map and a confidence score map corresponding to a captured input image using a neural network. The image processing apparatus 1410 may generate illumination information based on the illumination map and the confidence score map, and the image processing apparatus 1410 may modify a captured input image (e.g., a visible light image) based on the illumination information. The image processing apparatus 1410 may operate one or more neural networks for performing multiple image processing tasks. The neural networks may be trained at another device, such as on a server. In some cases, parameters for one or more neural networks are trained on the server and transmitted to the image processing apparatus 1410. In other examples, parameters for one or more neural networks are trained prior to manufacturing the image processing apparatus 1410.

In some cases, the image processing apparatus 1410 is implemented on a server. The server provides one or more functions to devices/users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose image processing device, a personal computer, a laptop computer, a mainframe computer, a supercomputer, or any other suitable processing apparatus.

In some cases, training data (e.g., training images for one or more image processing tasks) for training one or more machine learning models (e.g., implemented by the image processing apparatus 1410) may be stored at the database 1415. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with database controller. In other cases, a database controller may operate automatically without user interaction.

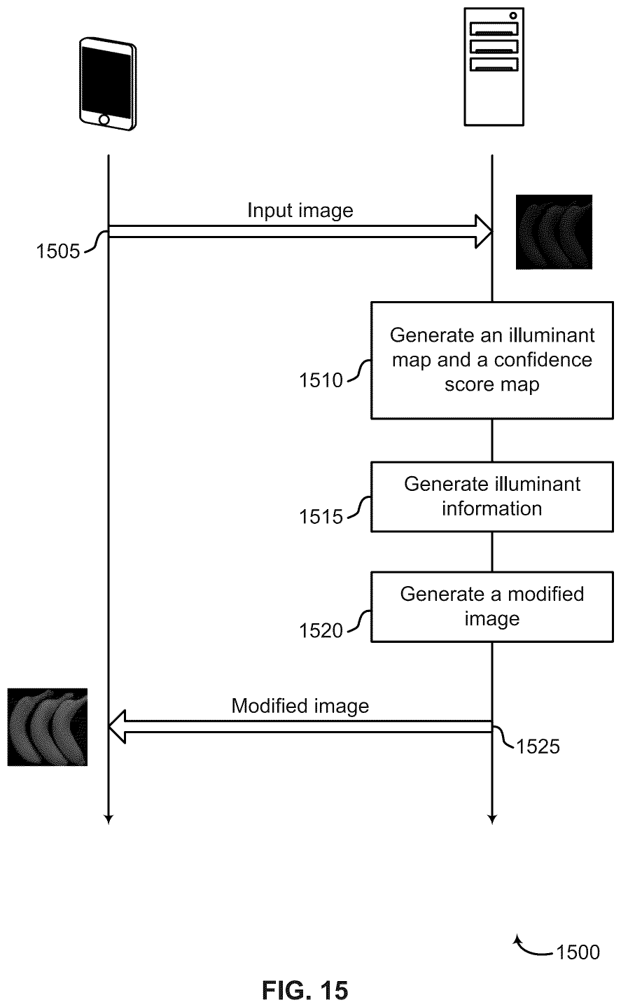

FIG. 15 illustrates a method 1500 for image processing. For example, the method may include aspects of an image processing process, which may be performed by an image processing system or an image processing apparatus as described with reference to FIGS. 1-14.

At step 1505, an input image is provided by a capturing device (e.g., a camera) to an image processing apparatus. In some examples, the captured image may have incorrect or undesirable coloring based on the lighting conditions when the image was captured. The input image may be a visible light image. In some examples, one or more infrared images may also be provided by the capturing device (e.g., or another device) to the image processing apparatus. The visible light image and the one or more infrared images may make up an input image set.

At step 1510, the image processing apparatus generates an illuminant map and a confidence score map based on the input image set. For example, a server may train a first sub-model of a neural network model to generate an illuminant map based on an input image set, and the server may train a second sub-model of a neural network model to generate a confidence score map based on the input image set.

At step 1515, the image processing apparatus generates illuminant information based on the illuminant map and the confidence score map. For example, a server may train a neural network model to generate illuminant information based on an illuminant map and a confidence score map. The illuminant information may represent the effects of illumination on the input image obtained at step 1505 (e.g., a visible light image).

At step 1520, the image processing apparatus generates a modified image based on the input image obtained at step 1505 (e.g., a visible light image) and the illuminant information. For example, a server may apply correction lighting data included in the illuminant information or generated based on the illuminant information to the input image to obtain a color-corrected (e.g., white-balanced) image that corrects the undesired coloring of the original input image.

The present description describes additional aspects of the methods, apparatuses, and/or systems related to the disclosure. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

Accordingly, the features described herein may be embodied in different forms and are not to be construed as being limited to the example embodiments described herein. Rather, the example embodiments described herein have been provided merely to illustrate some of the many possible ways of implementing the methods, apparatuses, and/or systems described herein that will be apparent after an understanding of the disclosure of this application. As used herein, “A or B,” “at least one of A and B,” “at least one of A or B,” “A, B, or C,” “at least one of A, B, and C,” and “A, B, or C,” may each include any one of the items listed together in the corresponding one of the phrases, or all possible combinations thereof. Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component. Throughout the disclosure, when an element is described as “connected to” or “coupled to” another element, it may be directly “connected to” or “coupled to” the other element, or there may be one or more other elements intervening therebetween. In contrast, when an element is described as “directly connected to” or “directly coupled to” another element, there may be no other elements intervening therebetween.

The terminology used herein is for describing various example embodiments only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of example embodiments, description of structures or functions that are thereby known after an understanding of the disclosure of the present application will be omitted when it is deemed that such description will cause ambiguous interpretation of the example embodiments. Example embodiments are described with reference to the accompanying drawings, and like reference numerals in the drawings refer to like elements throughout.

The examples described herein may be implemented using a hardware component, a software component and/or a combination thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. A method comprising:
forming an input image set by combining a visible light image and an infrared image;
estimating an illuminant map representing an illuminant configuration of the input image set and a confidence score map representing a correlation between the visible light image and the infrared image, using a neural network model; and
determining illuminant information of the visible light image based on the illuminant map and the confidence score map.

2. The method of claim 1, wherein
the illuminant map represents the illuminant configuration for each local area, and
the confidence score map represents the correlation between the visible light image and the infrared image for the each local area.

3. The method of claim 1, wherein the neural network model comprises:
a first sub-model configured to estimate the illuminant map from the input image set; and
a second sub-model configured to estimate the confidence score map from the input image set.

4. The method of claim 3, wherein the second sub-model comprises:
a first feature extraction model configured to extract a visible light feature map from the visible light image of the input image set;
a second feature extraction model configured to extract an infrared feature map from the infrared image of the input image set; and
a confidence score estimation model configured to estimate the confidence score map based on a correlation between the visible light feature map and the infrared feature map.

5. The method of claim 4, wherein the confidence score estimation model is configured to:
determine first data corresponding to one of the visible light feature map and the infrared feature map and second data corresponding to another one;
generate an attention map based on query data according to the first data and key data according to the second data; and
estimate the confidence score map based on value data according to one of the first data and the second data and the attention map.

6. The method of claim 1, wherein the infrared image comprises a multi-band.

7. The method of claim 1, wherein the determining of the illuminant information comprises:
obtaining a weighted sum between the illuminant map and the confidence score map; and
determining the illuminant information according to the weighted sum.

8. The method of claim 7, wherein the obtaining of the weighted sum comprises obtaining the weighted sum by summing vectors for each local area according to the illuminant map using a weight according to the confidence score map.

9. The method of claim 8, wherein
local areas of the visible light image and local areas of the infrared image form corresponding pairs,
the confidence score map comprises weights for each of the corresponding pairs, and
a weight of a corresponding pair corresponds to a correlation between visible light data and infrared data of the corresponding pair.

10. A non-transitory computer-readable storage medium storing instructions that, when executed by a processor, cause the processor to perform the method of claim 1.

11. An apparatus comprising:
a processor; and
a memory configured to store instructions executable by the processor,
wherein, in response to the instructions being executed by the processor, the processor is configured to:
form an input image set by combining a visible light image and an infrared image;
estimate an illuminant map representing an illuminant configuration of the input image set and a confidence score map representing a correlation between the visible light image and the infrared image, using a neural network model; and
determine illuminant information of the visible light image based on the illuminant map and the confidence score map.

12. The apparatus of claim 11, wherein
the illuminant map represents the illuminant configuration for each local area, and
the confidence score map represents the correlation between the visible light image and the infrared image for the each local area.

13. The apparatus of claim 11, wherein the neural network model comprises:
a first sub-model configured to estimate the illuminant map from the input image set; and
a second sub-model configured to estimate the confidence score map from the input image set.

14. The apparatus of claim 13, wherein the second sub-model comprises:
a first feature extraction model configured to extract a visible light feature map from the visible light image of the input image set;
a second feature extraction model configured to extract an infrared feature map from the infrared image of the input image set; and
a confidence score estimation model configured to estimate the confidence score map based on a correlation between the visible light feature map and the infrared feature map.

15. The apparatus of claim 14, wherein the confidence score estimation model is configured to:
determine first data corresponding to one of the visible light feature map and the infrared feature map and second data corresponding to another one;
generate an attention map based on query data according to the first data and key data according to the second data; and
estimate the confidence score map based on value data according to one of the first data and the second data and the attention map.

16. The apparatus of claim 11, wherein the infrared image comprises a multi-band.

17. The apparatus of claim 11, wherein, to determine the illuminant information, the processor is configured to:
obtain a weighted sum by summing vectors for each local area according to the illuminant map using a weight according to the confidence score map; and
determine the illuminant information according to the weighted sum.

18. An electronic device comprising:
a visible light camera configured to generate a visible light image;
an infrared camera configured to generate an infrared image; and
a processor configured to:
form an input image set by combining the visible light image and the infrared image;
estimate an illuminant map representing an illuminant configuration of the input image set and a confidence score map representing a correlation between the visible light image and the infrared image, using a neural network model; and
determine illuminant information based on the illuminant map and the confidence score map.

19. The electronic device of claim 18, wherein
the illuminant map represents the illuminant configuration for each local area, and
the confidence score map represents the correlation between the visible light image and the infrared image for the each local area.

20. The electronic device of claim 18, wherein the neural network model comprises:
a first sub-model configured to estimate the illuminant map from the input image set; and
a second sub-model configured to estimate the confidence score map from the input image set.
